(19) United States
(12) Patent Application Publication
(10) Pub. No.: US 2006/0083252 A1
(43) Pub. Date: Apr. 20, 2006

(54) Node detection method and node detector

(75) Inventors: Yuichi Sakuraba, Tokyo (JP); Yuji Miyata, Tokyo (JP); Akira Kataoka, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 11/206,849

(22) Filed: Aug. 19, 2005

(30) Foreign Application Priority Data
Oct. 20, 2004 (JP) 2004-305146

(51) Int. Cl. H04L 12/56; H04L 12/28

(52) U.S. Cl. 370/400

(57) ABSTRACT

A node detection method and a node detector that enable selection of a node detection method in accordance with the structure and operation of a network are realized. A node detection method for detecting a node connected to a network comprises: a first step of interpreting a first script related to cycle to decide a detection cycle; a second step of interpreting a second script used for selecting information to select next information to be acquired, when node detection timing has come; a third step of gathering the selected information via the network by using a matching protocol; a fourth step of interpreting the acquired information and storing node information when it is judged that a new node has been detected; and a fifth step of causing all the nodes that have been detected by the last node detection, to perform the second to fourth steps.

### BACKGROUND OF THE INVENTION

1. Field of the Invention

This invention relates to a node detection method and a node detector for detecting a node connected to a network, and particularly to a node detection method and a node detector that enable selection of a node detection method in accordance with the structure and operation of the network.

2. Description of the Related Art

Conventional node detection methods and node detectors for detecting a node connected to a network are disclosed in the following related art references.
JP-A-04-229742
JP-A-06-338884
JP-A-2000-253041
JP-A-2002-335245

FIG. 1 is a structural block diagram showing an example of the conventional node detection method described in JP-A-04-229742. FIG. 1 shows nodes 1, 2 and 3 such as computers and servers, which are network devices, a bridge 4, which is a device that interconnects segments of a local area network (LAN), a repeater 5, which is a device that relays signals between segments, a gateway 6, which is a device that converts protocols to each other for connection, a node detector 7, and networks 100, 101, 102 and 103 that form individual segments.

The node 1 is interconnected with the network 100. The nodes 2 and 3 are interconnected with the network 101. The bridge 4 interconnects the network 100 with the network 102. The repeater 5 interconnects the network 100 with the network 101. The gateway 6 interconnects the network 100 with the network 103. The node detector 7 is interconnected with the network 100.

The operation of the conventional example shown in FIG. 1 will now be described with reference to FIGS. 2, 3, 4, 5 and 6. FIG. 2 is a flowchart for explaining the operation of the node detector 7. FIGS. 3, 4, 5 and 6 are explanatory views for explaining flows of information.

At “S001” in FIG. 2, the node detector 7 judges whether detection timing has come or not. If it is judged that detection timing has come, the node detector 7 at “S002” in FIG. 2 sends a message to all the nodes on the network.

For example, the node detector 7 sends a message to the bridge 4, node 1, node 2, node 3 and gateway 6, which exist on the network 100 or the network 101 connected thereto by the repeater 5, as indicated by “BC01”, “BC02”, “BC03”, “BC04” and “BC05” in FIG. 3.

Specifically, the message uses a protocol such as the Internet control message protocol (ICMP), which is typical, or the simple network management protocol (SNMP) for acquiring an address list. The above-mentioned address list may be a routing table, transmission control protocol (TCP) connection table or the like.

At “S003” in FIG. 2, the node detector 7 prepares a list of nodes that have responded to the above-described message.

For example, if responses from the bridge 4, node 1, node 2, node 3 and gateway 6, which exist on the network 100 or the network 101 connected thereto by the repeater 5, are received, as indicated by “AQ11”, “AQ12”, “AQ13”, “AQ14” and “AQ15” in FIG. 4, the node detector 7 prepares a list of these nodes.

At “S004” in FIG. 2, the node detector 7 acquires an address list as described above from the nodes contained in the list, and at “S005” in FIG. 2, the node detector 7 adds the acquired address list to the list.

For example, by using a protocol such as SNMP, the node detector 7 acquires address lists from the bridge 4 and the gateway 6 contained in the list, as indicated by “GL21” and “GL22” in FIG. 5, and the node detector 7 adds the address lists to the list.

At “S006” in FIG. 2, the node detector 7 judges whether an additional node has been added to the list or not. If it is judged that an additional node has been added, the node detector 7 repeats the steps indicated by “S004” and “S005” in FIG. 2 on the newly added node.

For example, if it is judged that an additional node has been added, the node detector 7 acquires address lists from nodes existing on the network 102 and the network 103 via the bridge 4 and the gateway 6, as indicated by “GL31” and “GL32” in FIG. 6, and adds the address lists to the list.

By thus repeating the steps of sending a message to the nodes on the networks, generating a list of the nodes that have responded, and acquiring the address lists from the nodes contained in the list, it is possible to sequentially discover the nodes existing on the networks (segments) that are interconnected by the bridge 4 or the gateway 6.

However, in the conventional example shown in FIG. 1, since a message is sent to all the nodes on the networks on constant detection cycle, there is a problem of increase in traffic on the networks.

For example, since the contents of the address lists such as routing tables hardly change in a short period (detection cycle), the address lists such as routing tables need not be acquired in a short period (detection cycle). Also, because of the large data volume of the address lists such as routing tables, the traffic on the networks increases.

Moreover, for management of a network with a narrow band, a management policy for restraining the traffic is often employed. Therefore, it is difficult to directly apply the node detection method shown in FIG. 1 to the network employing such a management policy.

### SUMMARY OF THE INVENTION

It is an object of this invention to realize a node detection method and a node detector that enable selection of a node detection method in accordance with the structure and operation of a network.

### BRIEF DESCRIPTION OF THE DRAWINGS

FIG. 1 is a structural block diagram showing an example of conventional node detection method.

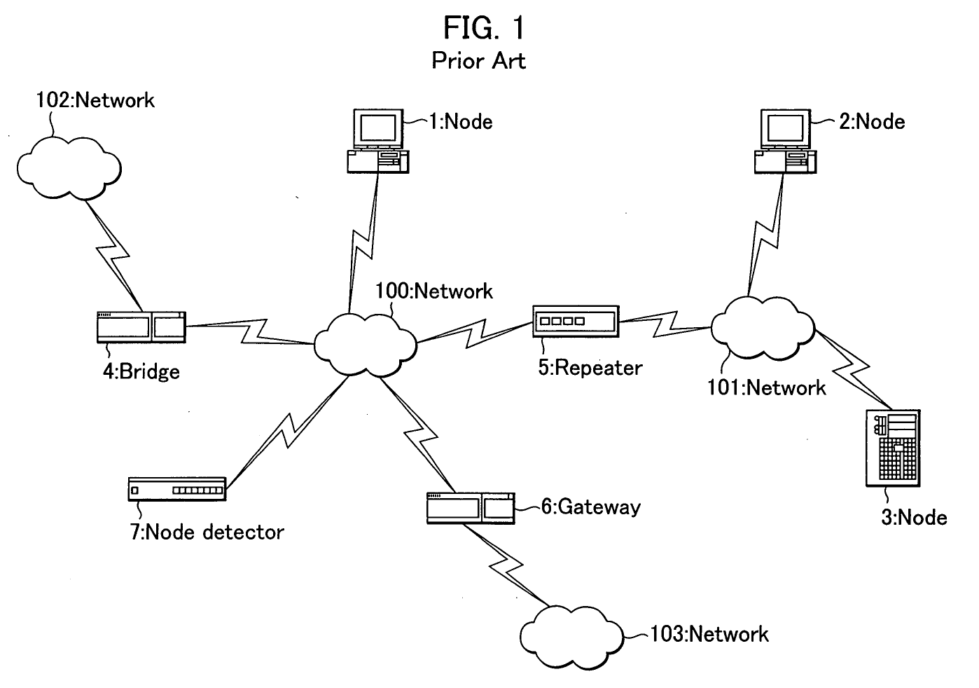

FIG. 2 is a flowchart for explaining the operation of a node detector.

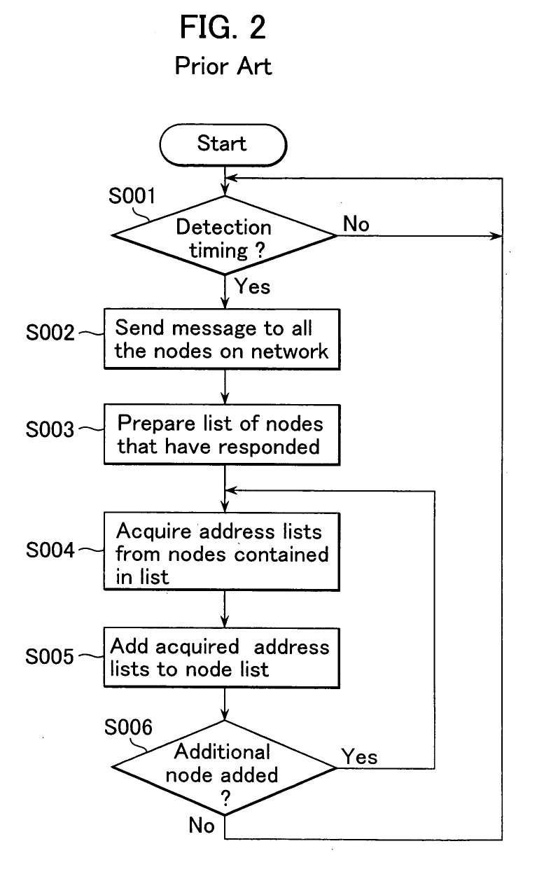

FIG. 3 is an explanatory view for explaining flows of information.

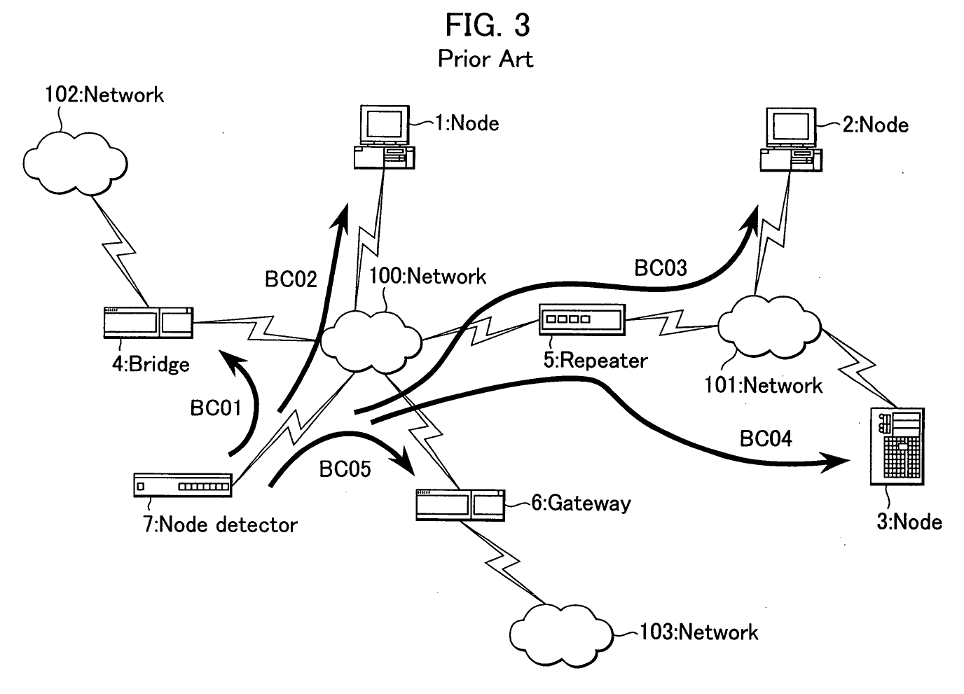

FIG. 4 is an explanatory view for explaining flows of information.

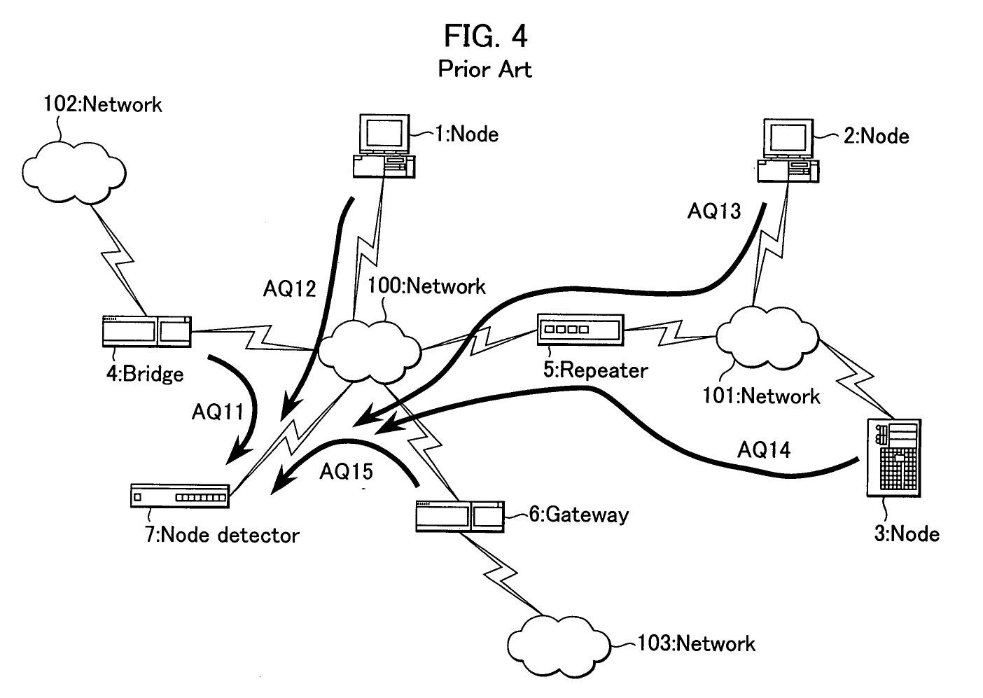

FIG. 5 is an explanatory view for explaining flows of information.

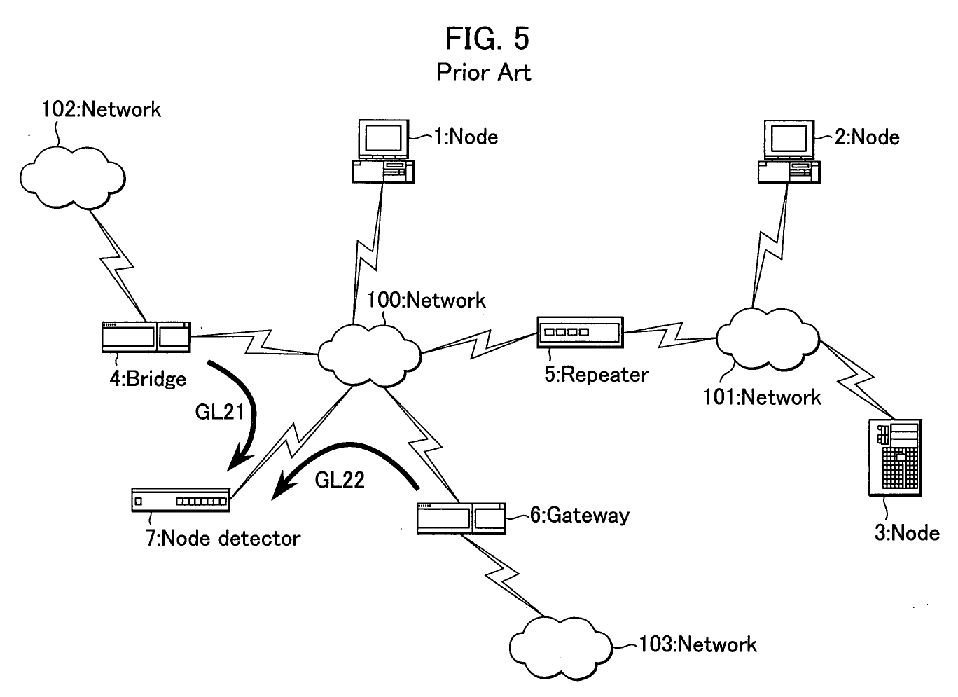

FIG. 6 is an explanatory view for explaining flows of information.

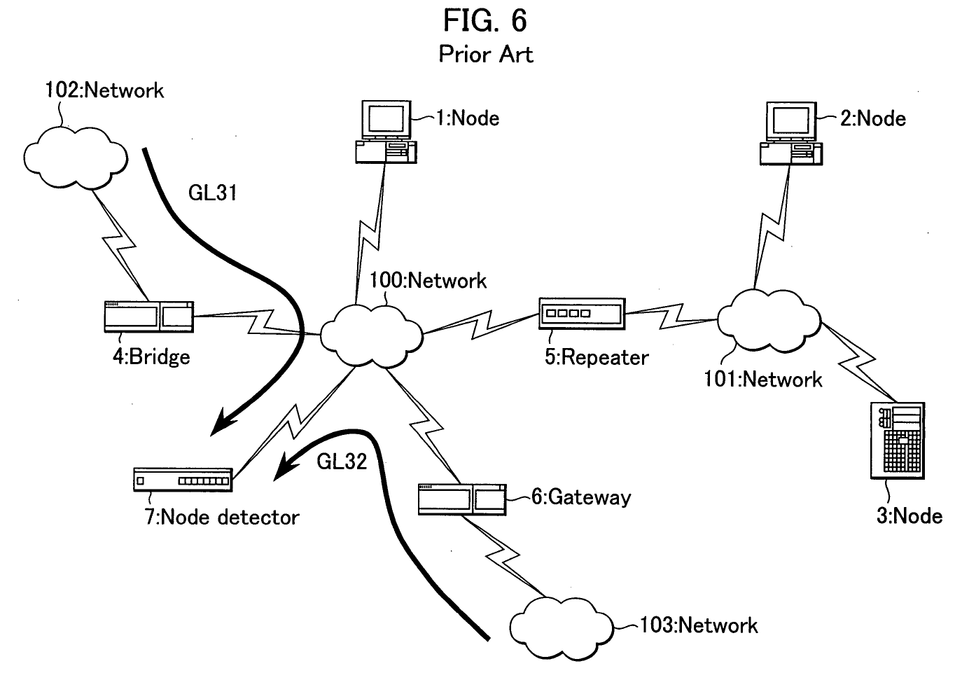

FIG. 7 is a structural block diagram showing an embodiment of a network system using a node detector according to this invention.

FIG. 8 is a structural block diagram for explaining a specific example of the node detector.

FIG. 9 is an explanatory view showing the correlations between functions of frameworks operated by an arithmetic control unit.

FIG. 10 is a flowchart for explaining the operation of the arithmetic control unit.

FIG. 11 is an explanatory view for explaining flows of information between the functions.

FIG. 12 is an explanatory view for explaining flows of information between the functions.

FIG. 13 is an explanatory view for explaining flows of information between the functions.

FIG. 14 is an explanatory view for explaining flows of information in a network.

FIG. 15 is an explanatory view for explaining flows of information between the functions.

### DETAILED DESCRIPTION OF THE PREFERRED EMBODIMENTS

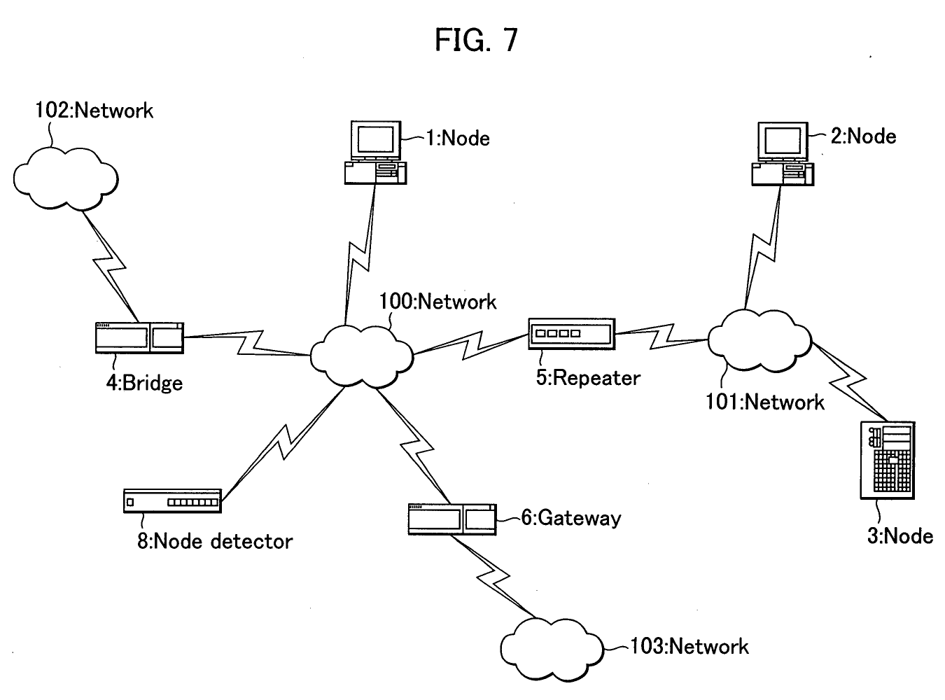

Hereinafter, this invention will be described in detail with reference to the drawings. FIG. 7 is a structural block diagram showing an embodiment of a network system using a node detector according to this invention.

FIG. 7 shows nodes 1, 2 and 3 such as computers and servers, which are network devices, a bridge 4, which is a device that interconnects segments of a local area network (LAN), a repeater 5, which is a device that relays signals between segments, a gateway 6, which is a device that converts protocols to each other for connection, a node detector 8, and networks 100, 101, 102 and 103 that form individual segments.

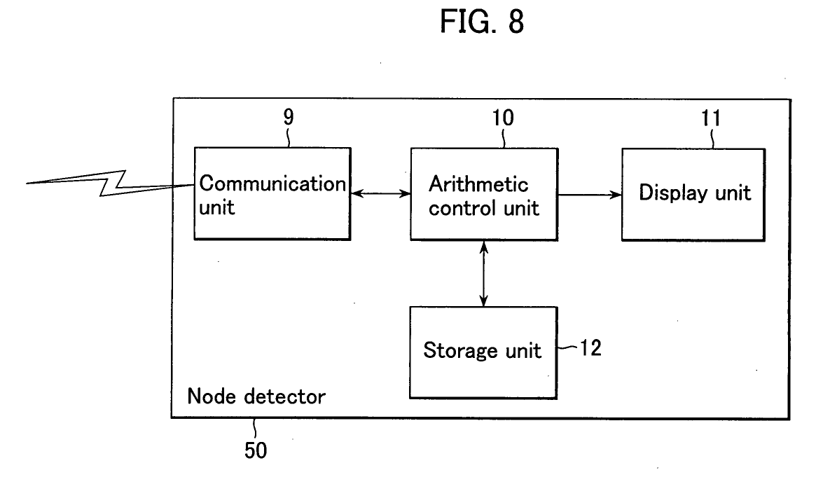

FIG. 8 is a structural block diagram for explaining a specific example of the node detector 8. FIG. 8 shows a communication unit 9 that communicates with the networks (segments) connected thereto, an arithmetic control unit 10 such as a central processing unit (CPU) that controls the entire device, a display unit 11 such as a cathode ray tube (CRT), liquid crystal display (LCD) or light-emitting diode (LED), and a storage unit 12 such as a hard disk or random access memory (RAM) that stores programs to realize functions to operate the device and in which acquired node information, a customized script related to cycle, a customized script used for selecting the next information to be acquired, and the like are saved. The communication unit 9, the arithmetic control unit 10, the display unit 11 and the storage unit 12 form a node detector 50.

The communication unit 9 is connected to the network (segment) 100 and is interconnected with the arithmetic control unit 10. A display output of the arithmetic control unit 10 is connected to the display unit 11. An input/output of the storage unit 12 is interconnected with the arithmetic control unit 10.

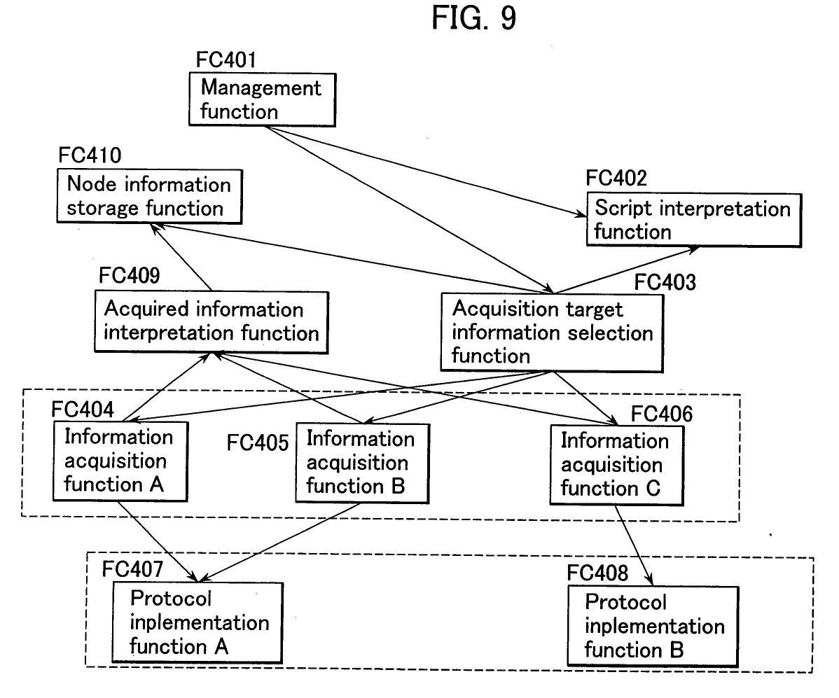

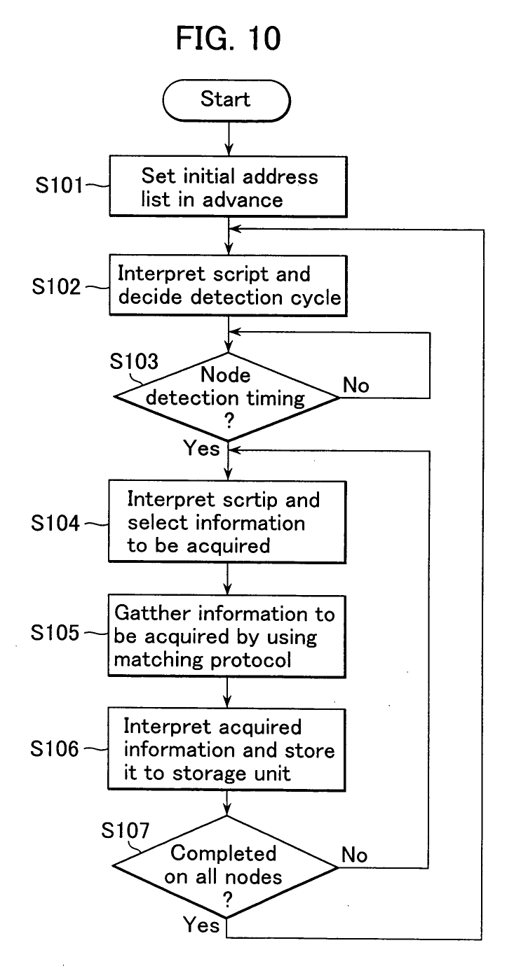

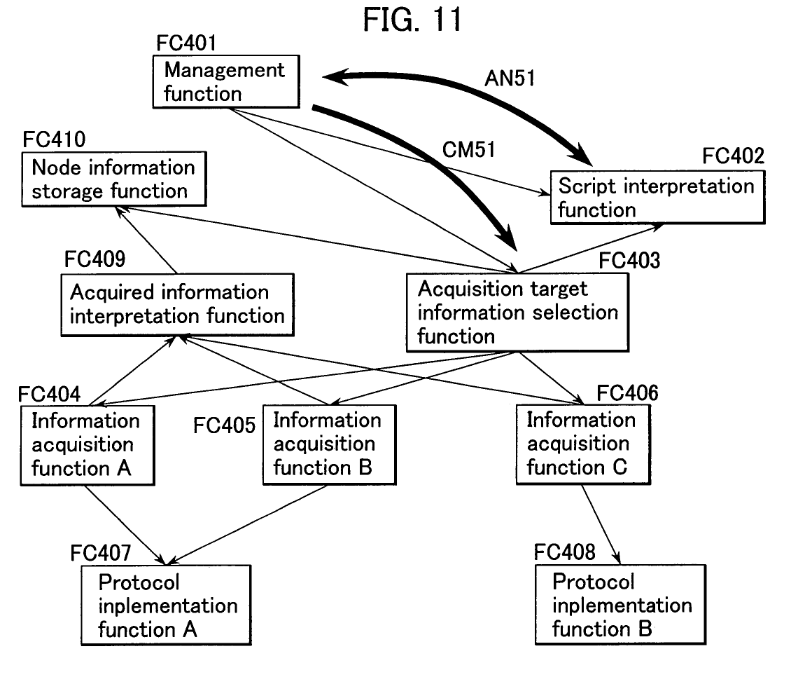

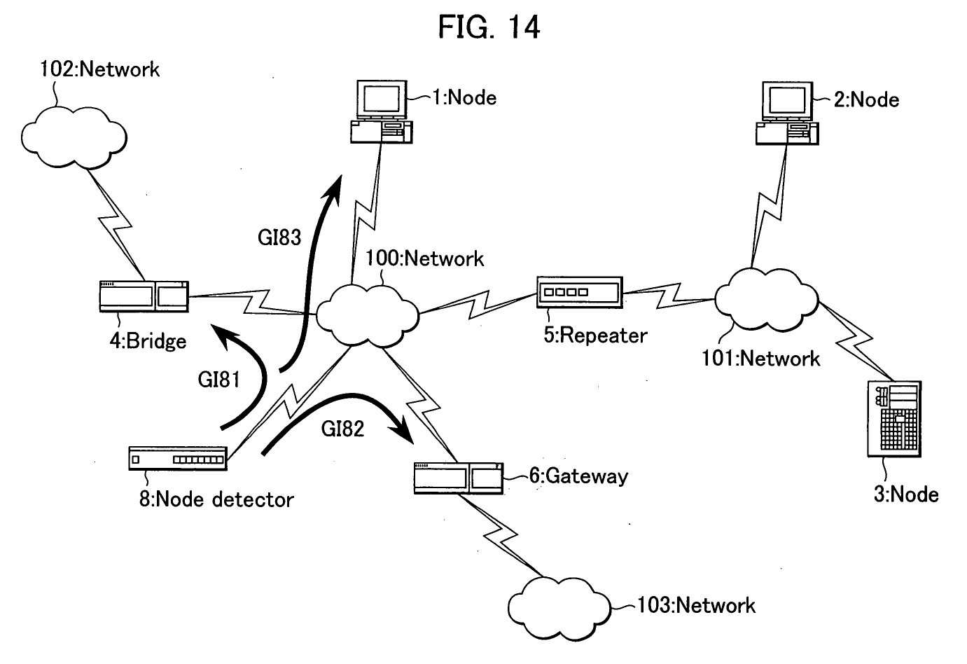

The operation in the embodiment shown in FIG. 7 will now be described with reference to FIGS. 9, 10, 11, 12, 13, 14 and 15. FIG. 9 is an explanatory view showing the correlations between functions of frameworks operated by the arithmetic control unit 10. FIG. 10 is a flowchart for explaining the operation of the arithmetic control unit 10. FIGS. 11, 12, 13 and 15 are explanatory views for explaining flows of information between the functions. FIG. 14 is an explanatory view for explaining flows of information in a network.

FIG. 9 shows the functions of frameworks operated by the arithmetic control unit 10 and their correlations. The frameworks are described by scripts. For example, a conditional clause such as “if . . . ” clause and a logical operator such as “AND” or “OR” are combined to form a framework.

In FIG. 9, “FC401” denotes a management function to manage the entire device. “FC402” denotes a script interpretation function to interpret a customized script related to cycle and a customized script used for selecting the next information to be acquired. “FC403” denotes an acquisition target information selection function to select the next information to be acquired on the basis of the latter script. “FC404”, “FC405” and “FC406” denote information acquisition functions (A to C) prepared corresponding to the types of information to be acquired. “FC407” and “FC408” denote protocol implementation functions (A and B) to perform transmission and reception corresponding to a protocol used for acquiring information. “FC409” denotes an acquired information interpretation function to interpret acquired information. “FC410” denotes a node information storage function to store acquired information and information used for selecting information to the storage unit 12.

The management function denoted by “FC401” in FIG. 9 controls the script interpretation function denoted by “FC402” in FIG. 9 and the acquisition target information selection function denoted by “FC403” in FIG. 9. The acquisition target information selection function denoted by “FC403” in FIG. 9 controls the information acquisition functions A, B and C denoted by “FC404”, “FC405” and “FC406” in FIG. 9 and the node information storage function denoted by the “FC410” in FIG. 9.

The information acquisition functions A, B and C denoted by “FC404”, “FC405” and “FC406” in FIG. 9 are prepared corresponding to the types of information to be acquired. Therefore, for example, the information acquisition function A denoted by “FC404” in FIG. 9 can be set to acquire information such as accessibility using ICMP, and the information acquisition function B denoted by “FC405” in FIG. 9 can be set to acquire information such as a routing table.

The information acquisition functions A, B and C denoted by “FC404”, “FC405” and “FC406” in FIG. 9 employ a plug-in form. Therefore, the information acquisition functions can be easily added or deleted even after the operation of the node detector 8 or the like.

The information acquisition functions A and B denoted by “FC404” and “FC405” in FIG. 9 control the protocol implementation function A denoted by “FC407” in FIG. 9. The information acquisition function C denoted by “FC406” in FIG. 9 controls the protocol implementation function B denoted by “FC408” in FIG. 9.

For example, the protocol implementation function A denoted by “FC407” in FIG. 9 performs communication using ICMP as its protocol, and the protocol implementation function B denoted by “FC408” in FIG. 9 performs communication using SNMP as its protocol.

Meanwhile, the information acquisition functions A, B and C denoted by “FC404”, “FC405” and “FC406” in FIG. 9 control the acquired information interpretation function denoted by “FC409” in FIG. 9. The acquired information interpretation function denoted by “FC409” in FIG. 9 controls the node information storage function denoted by “FC410” in FIG. 9.

At “S101” in FIG. 10, the arithmetic control unit 10 sets an initial address list in advance. Specifically, an initial address list is set for each of the information acquisition functions.

At “S102” in FIG. 10, the arithmetic control unit 10 interprets the customized script related to cycle, which is stored in the storage unit 12, and decides the detection cycle. Specifically, the management function denoted by “FC401” in FIG. 11 causes the script interpretation function denoted by “FC402” in FIG. 11 to interpret the customized script related to cycle, as indicated by “AN51” in FIG. 11, and thus decides the detection cycle.

For example, if the number of nodes that have been previously discovered is large, there can be many undiscovered nodes and therefore the detection cycle is made shorter. Alternatively, if no node has been discovered previously or if there is high traffic, the detection cycle is made longer. In this manner, the detection cycle is decided by interpreting the customized script related to cycle.

At “S103” in FIG. 10, the arithmetic control unit 10 judges whether node detection timing has come or not. If it is judged that node detection timing has come, the arithmetic control unit 10 starts detecting nodes. Specifically, the management function denoted by “FC401” in FIG. 11 controls the acquisition target information selection function denoted by “FC403” in FIG. 11 to select the next information to be acquired, as indicated by “CM51” in FIG. 11.

At “S104” in FIG. 10, the arithmetic control unit 10 interprets the customized script used for selecting information and selects the next information to be acquired.

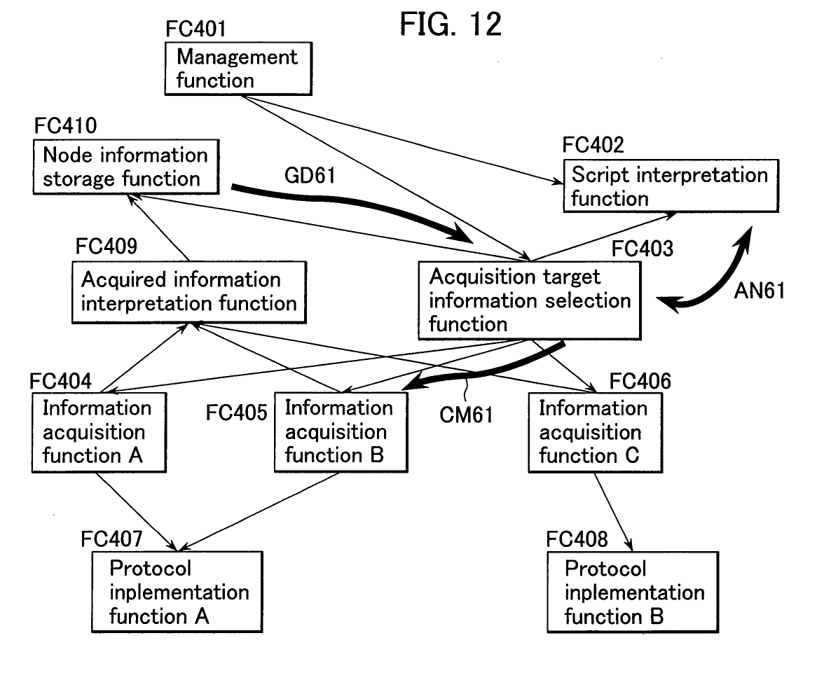

Specifically, the acquisition target information selection function denoted by “FC403” in FIG. 12 reads out node information (node state, type of information, time of discovery and the like) from the node information storage function denoted by “FC410” in FIG. 12, as indicated by “GD61” in FIG. 12. The acquisition target information selection function also causes the script interpretation function denoted by “FC402” in FIG. 12 to interpret the customized script used for selecting information on the basis of the read-out node information, as indicated by “AN61” in FIG. 12, and thus decides the information to be acquired.

For example, if the script is interpreted on the basis of the node information read out from the node information storage function denoted by “FC410” in FIG. 12 and information that the node has an SNMP agent is extracted, information such as a routing table using SNMP is selected.

Alternatively, for example, on the assumption that one type of information is to be acquired at a time, if the script is interpreted on the basis of the node information and it is judged that it is possible to acquire plural types of information, information of higher priority is preferentially selected.

At “S105” in FIG. 10, the arithmetic control unit 10 gathers the information to be acquired via the network by using the matching protocol. Specifically, the acquisition target information selection function denoted by “FC403” in FIG. 12 instructs the information acquisition function B denoted by “FC405” in FIG. 12 to gather the selected information, as indicated by “CM61” in FIG. 12.

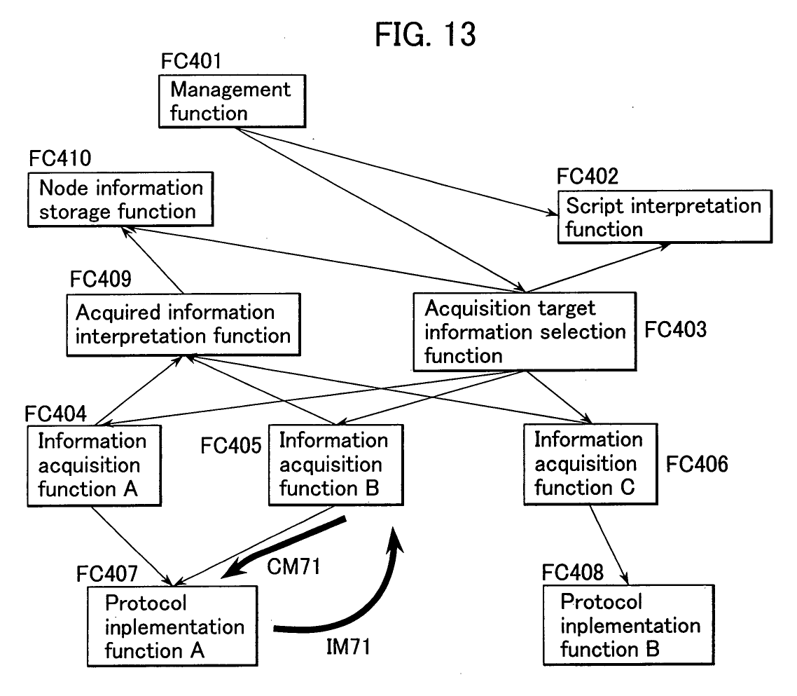

Then, the information acquisition function B denoted by “FC405” in FIG. 13 requests the protocol implementation function A denoted by “FC407” in FIG. 13 that performs transmission and reception corresponding to a protocol matching the information to be gathered, to gather the information, as indicated by “CM71” in FIG. 13

The protocol implementation function A denoted by “FC407” in FIG. 13 gathers the selected information by using the implemented protocol, as indicated by “GI81”, “GI82” and “GI83” in FIG. 14.

At “S106” in FIG. 10, the arithmetic control unit 10 interprets the acquired information, and if it is judged that a new node has been detected, the arithmetic control unit 10 stores the node information to the storage unit 12. Specifically, the information acquisition function B denoted by “FC405” in FIG. 13 acquires the selected information from the protocol implementation function A denoted by “FC407” in FIG. 13, as indicated by “IM71” in FIG. 13.

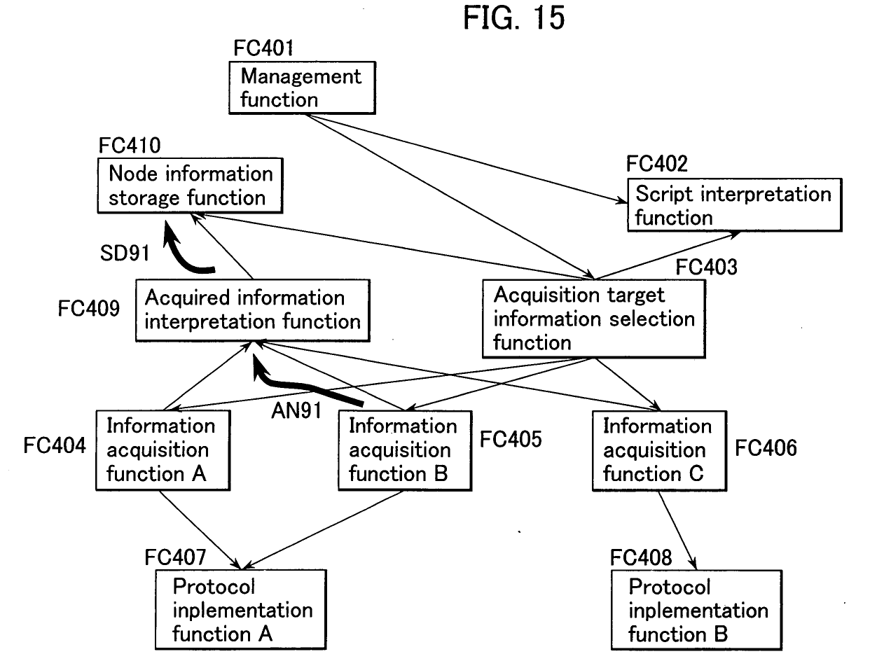

Then, the information acquisition function B denoted by “FC405” in FIG. 15 passes the acquired information to the acquired information interpretation function denoted by “FC409” in FIG. 15 and causes the acquired information interpretation function to interpret the acquired information, as indicated by “AN91” in FIG. 15. If it is judged that a new node has been detected, the acquired information interpretation function denoted by “FC409” in FIG. 15 passes the node information to the node information storage function denoted by “FC410” in FIG. 15 and causes the node information to be stored therein, as indicated by “SD91” in FIG. 15.

Finally, at “S107” in FIG. 10, the arithmetic control unit 10 judges whether the steps “S104” to “S106” in FIG. 10 have been performed at all the nodes that have been detected by the last node detection. If it is judged that the steps have not been completed at all the nodes, the arithmetic control unit 10 returns to step “S104” in FIG. 10. If it is judged that the steps have been completed at all the nodes, the arithmetic control unit 10 returns to step “S102”.

Also, the arithmetic control unit 10 causes the display unit 11 to properly display the result of node detection, when necessary.

Thus, the plural information acquisition functions that can be plugged in for each information to be acquired are provided, and the plural protocol implementation functions to perform transmission and reception in accordance with the protocol used for acquiring information are provided. The arithmetic control unit 10 interprets the customized script to decide the detection cycle, and interprets the customized script to decide the information to be acquired. Then, the arithmetic control unit 10 gathers and interprets the information by using the matching information acquisition function and protocol implementation function. When a new node is detected, the arithmetic control unit 10 stores the node information to the storage unit 12. This enables selection of a node detection method in accordance with the structure and operation of the network.

More specifically, by changing the script not to check the accessibility of a node using ICMP or not to acquire again a routing table that has been acquired once, and thus customizing the selection of information to be acquired, it is possible to select a node detection method in accordance with the structure and operation of the network.

Moreover, the customized script related to cycle is interpreted and the detection cycle is thus decided, as described above. For example, if the number of nodes that have been previously discovered is large, there can be many undiscovered nodes and therefore the detection cycle is made shorter. Alternatively, if no node has been discovered previously or if there is high traffic, the detection cycle is made longer. This enables customization of the detection cycle and selection of a node detection method in accordance with structure and operation of the network.

By adding an information acquisition function to a framework or deleting it from the framework by plug-in, it is possible to acquire a new type of information even during the operation.

Moreover, since the functions except the information acquisition functions and the protocol implementation functions do not depend on the protocol, adding a protocol implementation function or the like enables discovery of a node on a radio network conformable to, for example, “Bluetooth”, “IEEE802.11x” or the like. Thus, communications using various protocols can be handled.

In the description of the embodiment shown in FIG. 7 and the other drawings, discovery of the network devices such as the bridge or the gateway is described as an example. However, the framework used for the node detector can also be applied to management of applications or the like. In this case, it is possible to detect an application that is being used.

Also, by using the framework used for the node detector, it is possible to detect whether a web server is operating at a node within the network or not. Specifically, node conversion is performed as a first step, and as a second step, “port number 80” used for the hypertext transfer protocol (HTTP) is accessed with respect to the discovered node. If there is a response, it is possible to confirm that the web server is operating at this node.

In the case of communicating with devices such as a sensor installed in a plant or the like by using a digital network such as a field bus, which is used for communication between measurement control devices within a plant, it is possible to use the framework used for the node detector for automatically acquiring information of these devices (sensor and the like).

For example, by using the framework used for the node detector, it is possible to detect changes in arrangement of various devices such as a sensor and an air-conditioning system within a building. It is also possible to acquire information such as the status and parameters of devices that have been changed in arrangement.

This invention has the following effects.

According to the inventions of claims 1, 2, 3, 4, 5, 8 and 9, plural information acquisition functions that can be plugged in for each information to be acquired are provided, and plural protocol implementation functions to perform transmission and reception in accordance with a protocol used for acquiring information are provided. An arithmetic control unit interprets a customized script to decide a detection cycle, and interprets a customized script to decide information to be acquired. Then, the arithmetic control unit gathers and interprets the information by using the matching information acquisition function and protocol implementation function. When a new node is detected, the arithmetic control unit stores the node information to a storage unit. This enables selection of a node detection method in accordance with the structure and operation of the network.

According to the invention of claim 6, by adding an information acquisition function to a framework or deleting it from the framework by plug-in, it is possible to acquire a new type of information even during the operation.

According to the invention of claim 7, since the functions except the information acquisition functions and the protocol implementation functions do not depend on the protocol, adding a protocol implementation function or the like enables handling of communications using various protocols.

According to the invention of claim 10, by applying a framework used for a node detector to management of applications or the like, it is possible to detect an application that is being used.

According to the invention of claim 11, by using the framework used for the node detector, it is possible to detect whether a web server is operating at a node within the network.

According to the invention of claim 12, by using the framework used for the node detector, it is possible to detect changes in arrangement of various devices such as a sensor and an air-conditioning system within a building, and it is also possible to acquire information such as the status and parameters of devices that have been changed in arrangement.

What is claimed is:

1. A node detection method for detecting a node connected to a network, the method comprising:
upon setting an initial address list in advance;
a first step of interpreting a first script related to cycle to decide a detection cycle;
a second step of interpreting a second script used for selecting information to select next information to be acquired, when node detection timing has come;
a third step of gathering the selected information via the network by using a matching protocol;
a fourth step of interpreting the acquired information and storing node information when it is judged that a new node has been detected; and
a fifth step of causing all the nodes that have been detected by the last node detection, to perform the second to fourth steps.

2. The node detection method as claimed in claim 1, wherein the first script is customizable.

3. The node detection method as claimed in claim 1, wherein the second script is customizable.

4. A node detector for detecting a node connected to a network, the node detector comprising:
a communication unit that performs communication via the network;
a storage unit in which acquired node information, a first script related to cycle and a second script used for selecting next information to be acquired are stored; and
an arithmetic control unit that set an initial address list in advance, interprets the first script to decide a detection cycle, interprets the second script to select next information to be acquired when node detection timing has come, gathers the selected information via the network by using a matching protocol, interprets the acquired information and storing node information to the storage unit when it is judged that a new node has been detected, and causes all the nodes that have been detected by the last node detection, to gather information.

5. The node detector as claimed in claim 4, wherein a framework operated by the arithmetic control unit comprises:
a management function to manage the entirety;
a script interpretation function to interpret the first and second scripts;
an acquisition target information selection function to select next information to be acquired, on the basis of the second script;
a plurality of information acquisition functions prepared corresponding to types of information to be acquired;
a protocol implementation function to perform transmission and reception in accordance with a protocol used for acquiring information;
an acquired information interpretation function to interpret acquired information; and
a node information storage function to store the acquired information and information used at the time of selecting information to the storage unit, and
wherein the management function controls the script interpretation function and the acquisition target information selection function, the acquisition target information selection function controls each of the information acquisition functions, the information acquisition functions control the protocol implementation function and controls the acquired information interpretation function, the protocol implementation function performs communication using an implemented protocol, and the acquired information interpretation function controls the node information storage function.

6. The node detector as claimed in claim 5, wherein the information acquisition functions can be added to or deleted from the framework by plug-in.

7. The node detector as claimed in claim 5, wherein the protocol implementation function is provided in the framework for each protocol that is used.

8. The node detector as claimed in claim 4 or 5, wherein the first script is customizable.

9. The node detector as claimed in claim 4 or 5, wherein the second script is customizable.

10. The node detector as claimed in claim 4 or 5, wherein the node detector is applied to management of an application.

11. The node detector as claimed in claim 4 or 5, wherein the node detector is applied to detection of a node at which a web server is operating, among the nodes within the network.

12. The node detector as claimed in claim 4 or 5, wherein the node detector is applied for automatically detecting information of an installed device.
